(19) United States
(12) Patent Application Publication
(10) Pub. No.: US 2002/0084634 A1
(43) Pub. Date: Jul. 4, 2002

(54) Airbag module for steering wheels

(76) Inventors: Heinz-Dieter Adomeit, Berlin (DE); Alexander Dettmer, Berlin (DE); Thomas Marotzke, Bergfelde (DE); Falk Ose, Berlin (DE); Andreas Winkler, Berlin (DE)

Correspondence Address: Michael D. Kaminski, FOLEY & LARDNER, Washington Harbour, 3000 K Street, N.W., Suite 500, Washington, DC, 20007-5143, US

(21) Appl. No.: 10/006,609

(22) Filed: Dec. 10, 2001

Related U.S. Application Data
(63) Continuation of application No. PCT/DE00/01890, filed on Jun. 8, 2000.

(30) Foreign Application Priority Data
Jun. 8, 1999 (DE) 199 27 024.4

(51) Int. Cl. B60R 21/22

(52) U.S. Cl. 280/731

(57) ABSTRACT

An airbag module for steering wheels. The airbag module includes a folded gas bag and a cover facing the driver of the vehicle, The cover is adapted to be fully opened only in its region which is located at the bottom in the straight-ahead position of the steering wheel.

### CROSS-REFERENCE TO RELATED PATENT APPLICATIONS

This is a continuation of International Application PCT/DE 00/01890, which has an international filing date of Jun. 8, 2000; this International Application was not published in English, but was published in German as WO 00/74981 A1.

### BACKGROUND OF THE INVENTION

The invention relates to an airbag module for steering wheels. Airbag modules for steering wheels are separated from the passenger compartment by means of covers which differ greatly in design. DE 197 35 438 A1 (incorporated herein by reference) discloses a cover that is torn open on three sides by the deploying gas bag. The cover is articulated on one side and is swung open about a hinge. Essentially the entire space enclosed by an airbag housing is exposed in the direction of the occupant, so that the gas bag can deploy freely in the direction of the occupant.

EP 0 884 359 A1 (incorporated herein by reference) discloses a cover which is articulated on two sides and includes a tear-open seam in the center. The deploying gas bag causes one part of the cover to swing open about a hinge in the direction of the windshield, while causing the second part to swing open about a hinge in the opposite direction. In this cover too, essentially the entire space enclosed by an airbag housing is exposed in the direction of the occupant.

WO 98/36 948 (incorporated herein by reference) discloses a gas bag cover which opens on four sides. In addition to parts which open in the direction of the windshield and in the opposite direction, this cover also has a part which opens to the left and a part which opens to the right. In this embodiment, as in the previously mentioned covers, the entire space enclosed by the airbag housing is exposed.

The disadvantage of these covers is that an occupant situated immediately in front of the steering wheel (referred to as an out-of-position (OOP) position) is subjected to a severe load after the airbag is activated. If the occupant is bearing directly against the steering wheel, the load is caused by the first gas bag bubble, which forms after ignition of the gas generator, and by the parts of the gas bag cover swinging open. Large flap parts, as can be found, for example, in the embodiment of covers in which company logos which are made of metal and are large in size on account of their design are incorporated, have a particularly disadvantageous effect. If the occupant is positioned somewhat further away, there is the risk of him being struck and hurt by the gas bag which is already partially deployed.

EP 0 844 143 A1 (incorporated herein by reference) discloses a steering wheel having a housing for receiving a gas bag, in which a main flap covering the main opening is provided. Secondary flaps arranged approximately perpendicularly with respect to the main flap are also provided. The secondary flaps cover openings which point downward with respect to the main direction of deployment. In the first phase of deployment, the gas bag does not deploy in the direction of the main direction of deployment, but rather deploys further downward in the direction of the driver's chest on account of the guiding function of the main flap. This reduces the risk of injury for an OOP occupant. However, there remains the possibility of the occupant being subjected to a severe load by the main flap turning over and, in a subsequent phase of deployment, by the impacting gas bag. Also, as in the previously described covers, the space enclosed by the airbag housing is virtually fully exposed, with the result that in a secondary collision the energy of an occupant impacting against the steering wheel is able to be dissipated to an insufficient extent.

The invention is therefore based on the object of improving, in the case of an airbag module for the steering wheel, both the protection of the occupant in the OOP position and also in the event of a secondary collision.

### SUMMARY OF THE INVENTION

According to an embodiment of the present invention, an airbag module for a steering wheel for protecting a driver of a vehicle is provided. The module includes a cover facing the driver. The cover being adapted to be fully opened only in a lower region located at the bottom of the cover when the steering wheel is in a straight-ahead position. The region adapted to be fully opened lies substantially below a line extending perpendicular to the direction of vehicle travel and intersecting the central axis of the steering column. The cover may include a central region, adjoining the lower region adapted to be opened, and an upper region, the upper and central regions having reinforcing elements preventing these regions from tearing open.

In an alternative embodiment of the present invention, the central and upper regions of the cover may be connected by deformable elements to a fixed component of the airbag module, the fixed component being located below the cover, wherein the central and upper regions of the cover are adapted to be opened by a predetermined amount, the deformable elements forming boundaries for the predetermined opening and providing energy-absorption in the event of a secondary impact of the driver.

The airbag module may further include a spacer in a region of the airbag module located at the top of the module when the steering wheel is in the straight-ahead position. The spacer may be deformable.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a cross-sectional view of a first embodiment of a driver's airbag module before ignition of the gas generator;

FIG. 2 is a plan view, as seen by the driver, of the airbag module according to FIG. 1 with the cover;

FIG. 3 is a plan view, as seen by the driver, of the airbag module according to FIG. 1 without the cover removed;

FIG. 4 is a cross-sectional view of the airbag module according to FIG. 1 after ignition of the gas generator, directly before the cover is opened;

FIG. 5 is a cross-sectional view of a second embodiment of a driver's airbag module before ignition of the gas generator;

FIG. 6 is a plan view, as seen by the driver, of the airbag module according to FIG. 5 with the cover;

FIG. 7 is a plan view, as seen by the driver, of the airbag module according to FIG. 5 with the cover removed;

FIG. 8 is a cross-sectional view of a third embodiment of a driver's airbag module before ignition of the gas generator;

FIG. 9 is a cross-sectional view of a fourth embodiment of a driver's airbag module before ignition of the gas generator;

FIG. 10 is a c rods-sectional view of a fifth embodiment of a driver's airbag module before ignition of the gas generator;

FIG. 11 is a cross-sectional view of the airbag module according to FIG. 10 after deployment of the gas bag;

FIG. 12 is an illustrative view of the gas bag deployment in a driver's airbag module according to the invention under OOP conditions;

FIG. 13 is an illustrative view of the free gas bag deployment in an airbag module according to the invention;

FIG. 14 is a side view of the spread-out gas bag before folding;

FIG. 15 shows the gas bag according to FIG. 14 after a first folding step;

FIG. 16 is a cross-sectional view of a sixth embodiment of a driver's airbag module before ignition of the gas generator;

FIG. 17 shows a plan view, as seen by the driver, of the airbag module according to FIG. 16 without a cover;

FIG. 18 is a cross-sectional of a seventh embodiment of a driver's airbag module with deformable in the form of ribs;

FIG. 19 is a cross-sectional view of an eighth embodiment of a driver's airbag module with a special design of the upper and central regions of the cover;

FIG. 20 is a cross-sectional view of a ninth embodiment with a special design of the lower region of the cover;

FIG. 21 shows the pre-folded gas bag according to FIG. 15 with an additional fixing means;

FIG. 22 shows the gas bag according to FIG. 21, in plan view:

FIG. 23 is a cross-sectional view of a tenth embodiment of a driver's airbag module with a special design of the gas-conducting device;

FIG. 24 shows a plan view of an eleventh embodiment of a driver's airbag module with a special means of tying down the gas bag cover;

FIG. 25 shows a partial section through the airbag module according to FIG. 24, along the line A-A;

FIG. 26 is a cross-sectional view of a twelfth embodiment of a driver's airbag module before ignition of the gas generator with a special configuration between the fixed cap region and gas bag package;

FIG. 27 is a cross-sectional-view of a thirteenth embodiment of a driver's airbag module before ignition of the gas generator with a further configuration between the fixed cap region and gas bag package;

FIG. 28 is a cross-sectional view of a fourteenth embodiment of a driver's airbag module before ignition of the gas generator with a special embodiment of the cover;

FIG. 29 is a cross-sectional view of a fifteenth embodiment of a driver's airbag module before ignition of the gas generator with a further configuration between the fixed cap region and gas bag package.

### DETAILED DESCRIPTION OF THE PREFERRED EMBODIMENTS

According to the embodiment of the present invention, an airbag module for a steering wheel is provided. The airbag module includes a cover facing the occupant. The cover only fully opens in a region which is located at the bottom of the cover when the steering wheel is located in the straight-ahead position. The gas bag initially expands downward after the gas generator is ignited, then deploys as customary so that the entire steering wheel is covered.

As a result of deploying the gas bag in the direction of the lower section of the steering wheel rim, the load for an occupant in the OOP position is reduced, particularly since the occupant's head and neck region is not caught hold of by the deploying gas bag. In addition, the cover does not include turning-over flap segments that put the occupant at risk. The load on the occupant is however, also reduced in the event of a secondary collision, because the central and upper regions of the cover remain substantially in the same position as before the airbag was deployed. As a result, the cover retains its energy-absorbing effectiveness after the gas bag collapses.

A further advantage of the embodiment of the present invention exists because the central and upper regions of the cover are not subject to any OOP-caused restrictions on the design with regard to the size of the company logo. Furthermore, actuating elements, such as a horn switch or other switches, may be accommodated in the central and upper regions of the cover. This was not previously possible, since all of the parts of the cover have been opened by the deploying gas bag.

The region of the cover that fully opens, preferably lies predominantly below a line which runs transversely with respect to the direction of travel of the vehicle and intersects the central axis of the steering column.

In one embodiment of the present invention of the cover includes reinforcing elements that prevent the cover from tearing open. In order to avoid the tearing-open of the cover by the deploying gas bag, provision can be made, as an alternative or in addition, for the central and upper regions of the cover to be connected to a gas-conducting device located below the cover or to a gas generator arranged there. In a further refinement provision may be made for at least the central and upper regions of the cover to consist, together with the steering wheel, of one component. This part of the cover is therefore then part of the steering wheel frame.

In a further embodiment of the present invention, provision may be made for the central and upper regions of the cover to be connected to a fixed component of the airbag module via deformable elements located below the cover. The deformable elements allow these regions of the cover to be opened by a predetermined, small amount. The deformable elements being positioned to constitute boundaries for the predetermined, small opening. When the regions of the cover open the deformable elements provide energy absorption elements in the event of a secondary impact of an occupant on the cover. The opening produced by the pivoting of the central and upper regions faces the lower region of the cover.

The protective effect of the cover is maintained in the event of a secondary impact even with the slight opening of the central and upper regions of the cover, which are additionally supported by the deformable elements.

The central and upper regions of the cover are preferably formed so that the regions cover at least approximately fully cover a gas-conducting device located below the cover and/or a gas generator located below it. In order to improve the protective effect in the event of a secondary impact, the central and upper regions of the cover are designed to absorb energy. In addition, or as an alternative, the space between the cover and the gas-conducting device or the gas generator can be filled with foam.

Furthermore, the space between the cover and the gas-conducting device or the gas generator can be bridged by at least one deformable element. The deformable element is preferably in the form of ribs and is injection-molded onto the upper or central region of the cover.

In a further embodiment, a spacer, which can be resilient or deformable, is provided in that region of the airbag module which is located at the top in the straight-ahead position of the steering wheel. As a result, in this upper region of the airbag module there is a section which is free of gas bag fabric.

There is preferably arranged a gas-conducting device, which predominantly has openings facing the fully opening, lower region of the cover. This gas-conducting device can additionally be designed to be deformable. The gas-conducting device is preferably an integral part of the gas generator or of the steering wheel frame, so as to be cost effective to manufacture.

A gas bag of the airbag module is preferably folded so that the folded gas bag lies next to the gas-conducting device or the gas generator. In this embodiment, the folded gas bag package can fully surround the adjacent element or surround the element in a U-shaped manner so that the region of the airbag module which is located at the top during straight-ahead travel is kept free of gas bag fabric, or so that the two limbs of the U-shaped gas bag package are in contact in that region of the airbag module which is located at the top during straight ahead travel. This arrangement assists in the gas bag being deployed in a manner favorable for the OOP case.

In a further refinement, means may be provided to at least temporarily fix the gas bag in place during the deployment above the gas-conducting device/the gas generator.

In a further embodiment, the gas bag may be tied down in the region of that gas outlet opening of the gas-conducting device which is oriented in the direction of the lower region of the cover. In this embodiment, there is no gas-bag layer between the gas-conducting device and those regions of the cover which are arranged above it.

In another embodiment, the gas bag is arranged so that only one layer lies above the gas-conducting device or above the gas generator. As in the above mentioned embodiment, this arrangement assists in the gas bag being deployed in a manner favorable for the OOP position.

The gas bag includes an opening for receiving gas from the generator arranged centrally with regard to the outer contour of the gas bag or arranged offset downward in the installation position provided in the straight-ahead position of the steering wheel.

In a further embodiment, the module may include functional elements, for example a horn contact or elements for actuating the car radio, to be arranged in the central and upper regions of the cover. Previously, functional elements of this type could not be fitted on the cover parts because in conventional modules the parts were torn open fully.

A further embodiment of the present invention, provides for the cover of the gas bag to have a side wall which is interrupted by tear-open lines in the region of the cover which is located at the bottom, in order to enable the bottom of the cover to open during deployment of the gas bag. The bottom of the cover preferably has cover segments which hinge into clearances between the spokes of the steering wheel when the gas bag is deployed. The side wall may be connected in the region of the cover segments to a support element for the gas generator. Preferably, the side wall is fastened to the support element at the base of the support element, thereby making available a large lateral opening cross section.

In a further embodiment, a cover plate is arranged between the upper/central region of the cover and the gas bag package of the airbag module. The cover plate absorbs forces and loads which arise during deployment of the gas bag, and as a result keeps them away from those regions of the cover which are not to be opened. In this embodiment, the cover plate is preferably connected to a gas-conducting device or to the gas generator. Preferably, the cover plate includes side walls which are connected to a support element for the gas generator. The cover plate and the support element may be integrally formed.

Yet another embodiment of the invention, provides for a cover having different materials in its upper and central regions and the lower region. For example, the upper and central regions of the cover may comprise a metal and the lower region of the cover may comprise a plastic. The upper and central regions of the cover and the lower region of the cover are preferably connected to one another in a form-fitting manner.

A further embodiment of the invention variant has means for continuously fixing the gas bag in place during its deployment above a gas-conducting device or the gas generator. These fixing means fix the gas bag in place at least below the central region of the cover during the deployment. For this purpose, the fixing means are preferably connected at least to the central region of the cover. The fixing means, preferably include an essentially transversely extending, clip-like element which is connected to a support element for the gas generator. However, the fixing means may include any suitable fastening element.

Through the airbag module of the present invention, the protective effect for occupants in the OOP position and in the event of a secondary impact of the occupant is improved, and advantages in terms of reduced costs of manufacturing the airbag module and the steering wheel are provided. Complete premanufacturing of the steering wheel together with the airbag module is also facilitated.

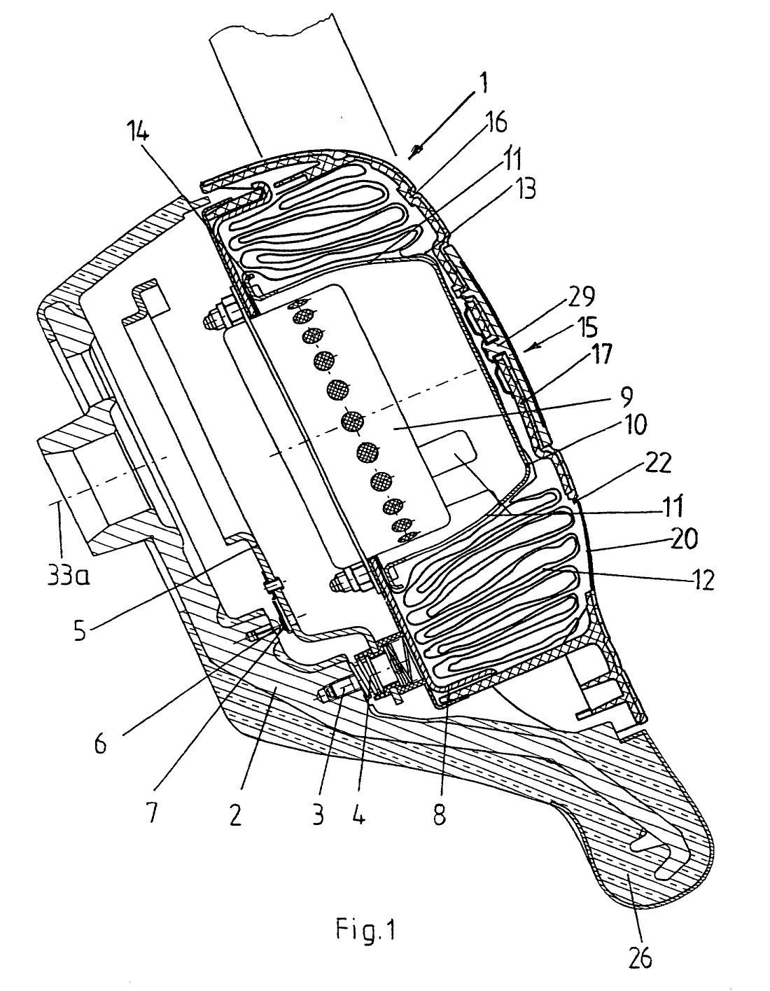

The driver's airbag module 1, shown in FIG. 1, is fastened to a steering wheel frame 2 by means of screws 3 (only one is shown in FIG. 1) so that the module can move in the direction of the screw axis. A spring 4 is placed in between each screw 3 and the frame. The screw 3 is also used to fasten a contact bridge 5 in such a manner that when the airbag module is pressed down, horn contacts 6, 7 are closed.

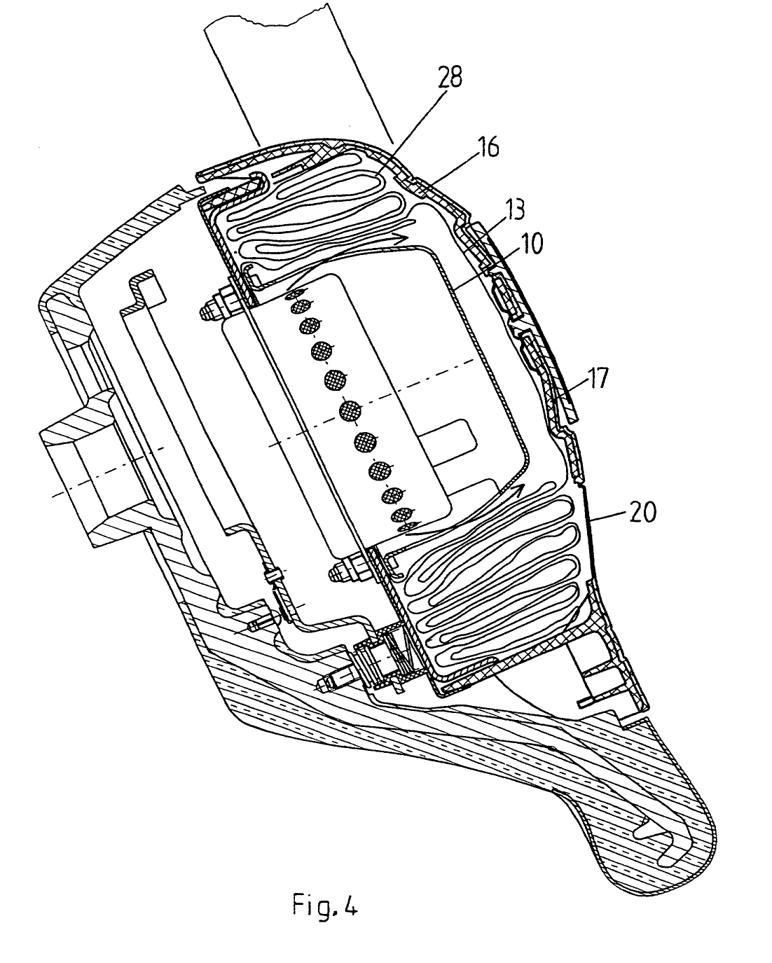

The airbag module 1 comprises a generator support 8 on which a cup-shaped gas generator 9 is fastened. The gas generator 8 is surrounded by a gas-conducting device 10 which has outflow openings 11. A gas bag 12 is arranged in a folded position to the side of the gas-conducting device. In the embodiment shown, just one gas-bag layer 13 extends above the gas-conducting device. As can be seen from FIG. 3, in this embodiment the folded gas bag pack surrounds the gas-conducting device 10. The gas bag is clamped between a flange 14 of the gas-conducting device 10 and the generator support 8 to the edge of the blow-in opening of the gas bag 12.

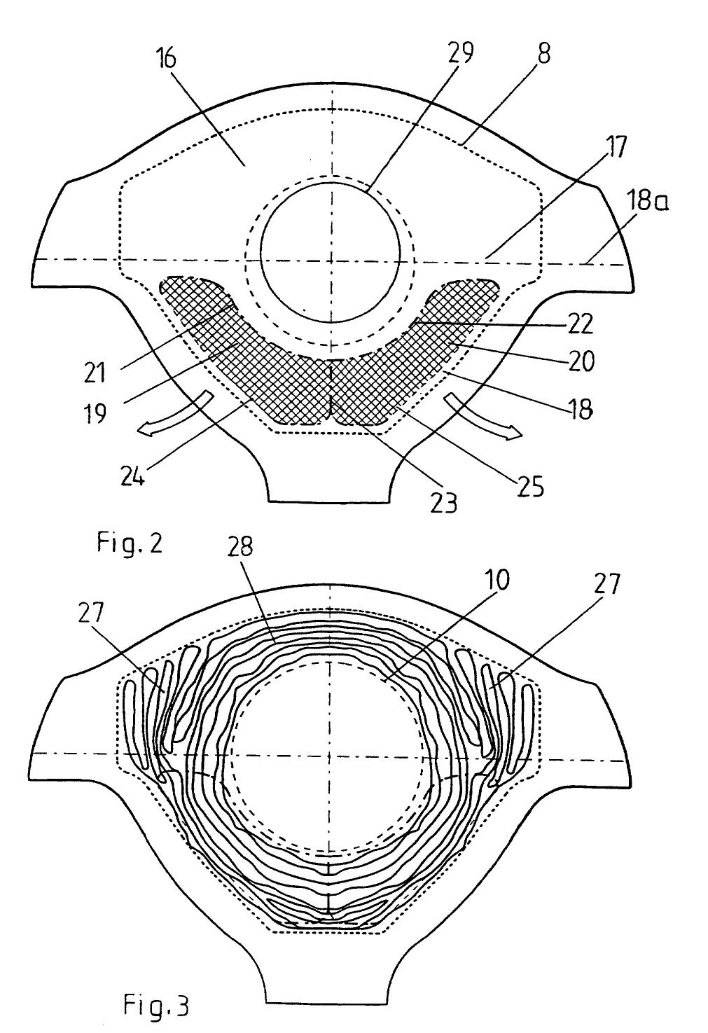

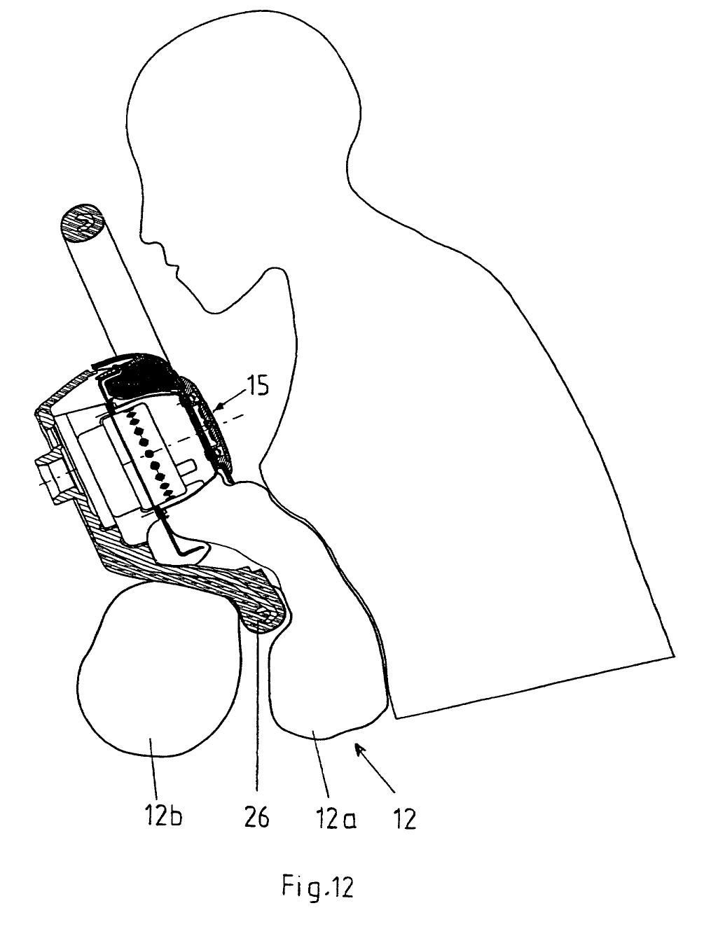

The gas bag pack is surrounded by a cover 15. This cover has an upper region 16 and a central region 17 which is adjoined by a lower region 18 (FIG. 2). The upper and central regions form a unit and are of a strength sufficient to ensure that this portion of the cover cannot be torn open by the deploying gas bag 12, but can only stretch. The lower region 18 consists of two segments 19, 20 which are separated, when the gas bag is deployed, from the central region 17 and from each other along tear-open lines 21, 22, 23 and swing open about hinges 24, 25. As a result, the gas bag can deploy downward in the direction of the lower region 26 of the steering wheel rim, as is shown in FIG. 12.

The lower region 18 of the cover extends below a line 18a, which runs transversely with respect to the direction of travel and intersects the central axis 33a of the steering column. When the gas bag is deployed in the straight-ahead position of the steering wheel, which is illustrated in FIG. 3, those folds 27 of the gas bag 12 which lie to the side of the gas-conducting device are also deployed to the side past the gas-conducting device 10. The folds 28 which are located at the top, are preferably deployed through the space between the gas-conducting device 10 and the upper and central regions 16, 17 of the cover. The deployment will be discussed again later.

A company logo 29 may be fastened to the upper and central regions 16, 17. Since these regions do not change their position after ignition of the gas generator, there are no OOP-induced restrictions in the design of the cover in respect of the size of the company logo.

As is apparent from FIG. 4, directly after ignition of the gas generator a bubble of the gas bag is formed above the gas-conducting device 10, as a result of which the upper and central regions 16 and 17 of the cover are stretched, so that the space between the cover and the gas-conducting device is enlarged to such an extent that the folds 28 can deploy through this space. Subsequently, or at the same time, the segments 19, 20 then open, so that the gas bag deploys in the direction of the lower region 26 of the steering wheel rim through the opening which then arises.

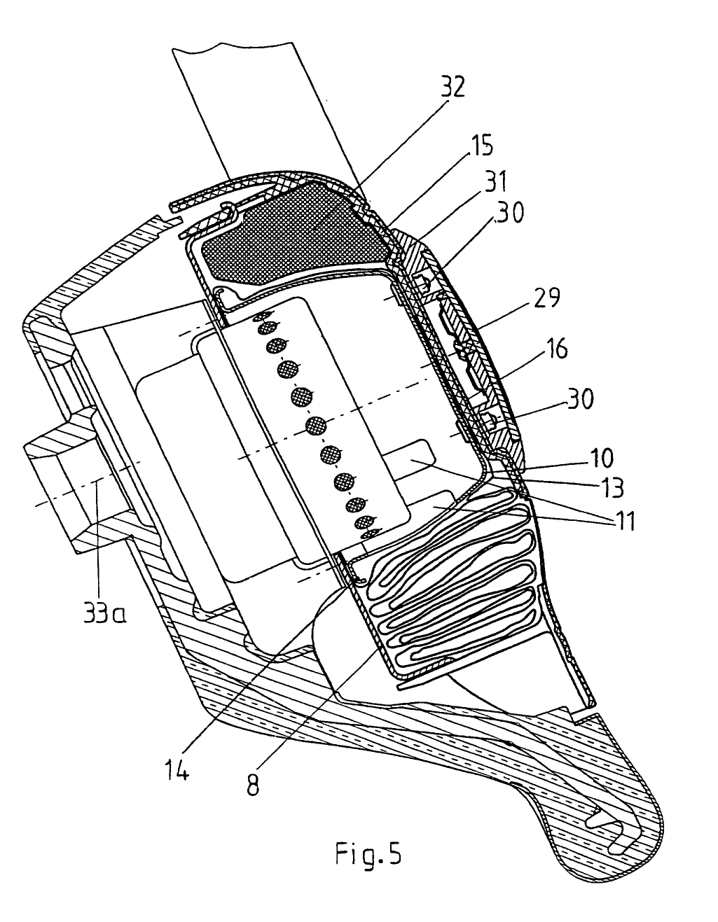

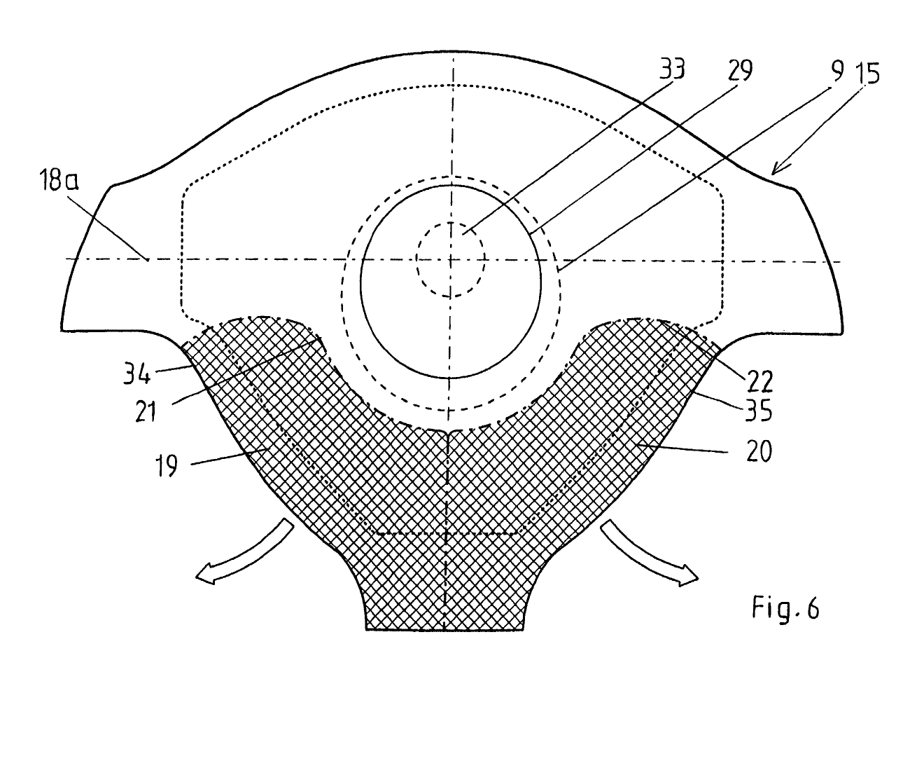

As shown in FIGS. 5-7, the present invention includes an embodiment in which the upper and central regions 15, 16 of the cover are connected to the gas-conducting device 10 by means of fastening elements 30. In this embodiment, the cover in this region lies between a support element 31 for the company logo 29 and the gas-conducting device. At this point, in this embodiment, the gas bag is clamped at the same time in its lower part, while in the region of the blow-in opening, the gas bag, as in the preceding exemplary embodiment, is fastened between the generator support 8 and the flange 14 of the gas-conducting device 10.

Since, in this embodiment, there is no free space between the gas-conducting device 10 and cover for the deployment of the gas bag, the gas bag is folded in a U-shaped manner, i.e. the folded gas bag pack extends only to the side of and below the gas-conducting device 10 with folds 36, 37. Above the gas-conducting device a spacer 32 is provided. The spacer may be deformable. The U-shape of the folded gas bag package.

As in a previous embodiment, the segments 19, 20 of the lower region of the cover extend below the line 18a which intersects the axis 33a of the steering column 33a. In this exemplary embodiment, the tear-open lines 21, 22 extend as far as the edges 34, 35 of the cover 15 thereby creating a relatively large opening cross section. The edges 34, 35 are configured as film hinges.

The outflow openings 11 of the gas-conducting device 10 are arranged so that the gases are predominantly discharged in the direction of the opening region of the cover.

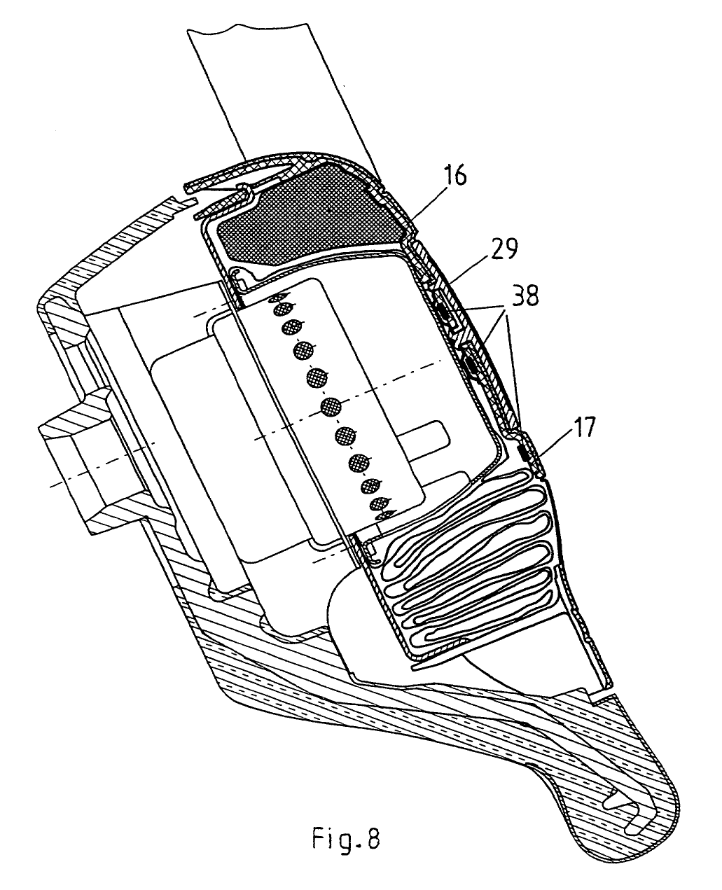

The embodiment of FIG. 8 differs from that of FIGS. 5 to 7 in that the upper and central regions 16, 17, which may be provided with the company logo 29 are not connected to the gas-conducting device. Rather, opening of these regions is prevented by metal reinforcing elements 38 in the regions 16, 17. The reinforcing elements 38 extend into the edge regions of the cover and are fastened there.

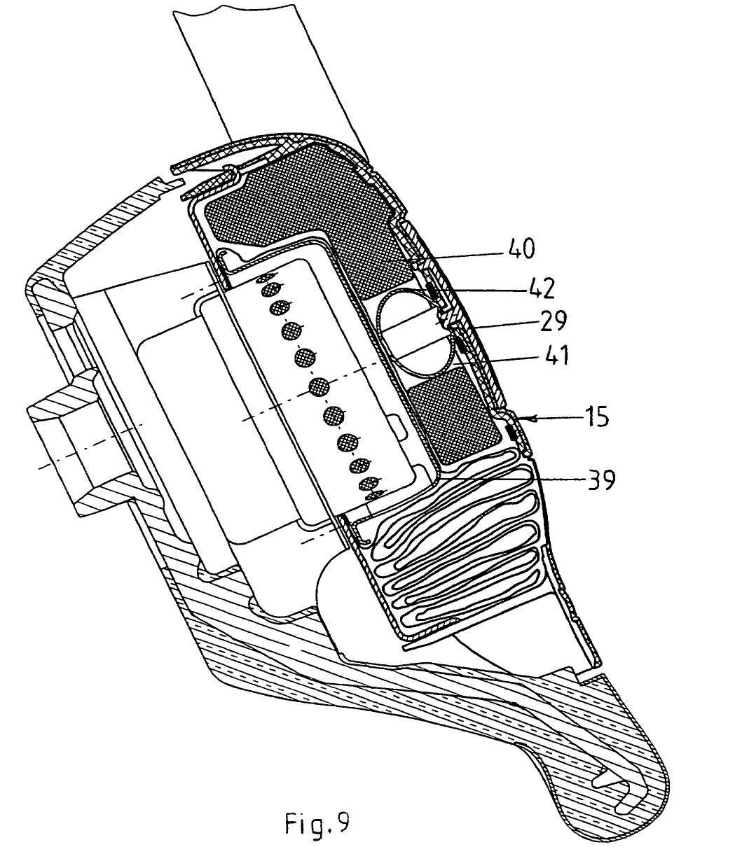

One way that the embodiment of FIG. 9 differs from that of FIG. 8 is the provision of a generally flat-shaped gas-conducting device 39. Furthermore, a spacer 40 extends in addition into the space between the cover 15 and the gas-conducting device 39. This spacer may be deformable. In addition, a deformable element 42 which is connected to the company logo 29 maybe placed into a clearance 41 in the spacer 40 to further improve the energy-absorption capability of the cover.

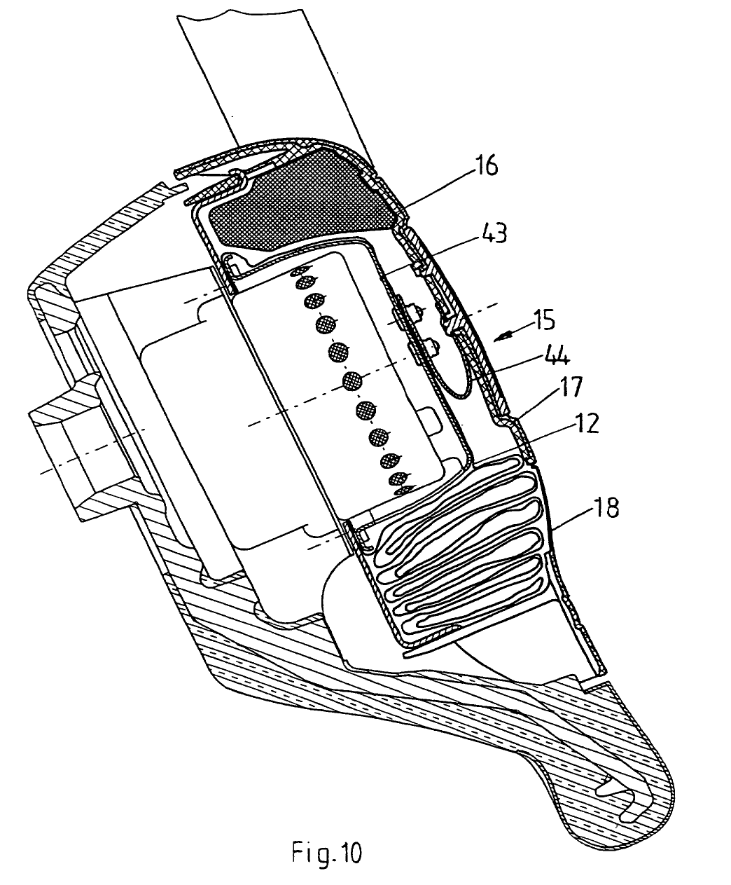

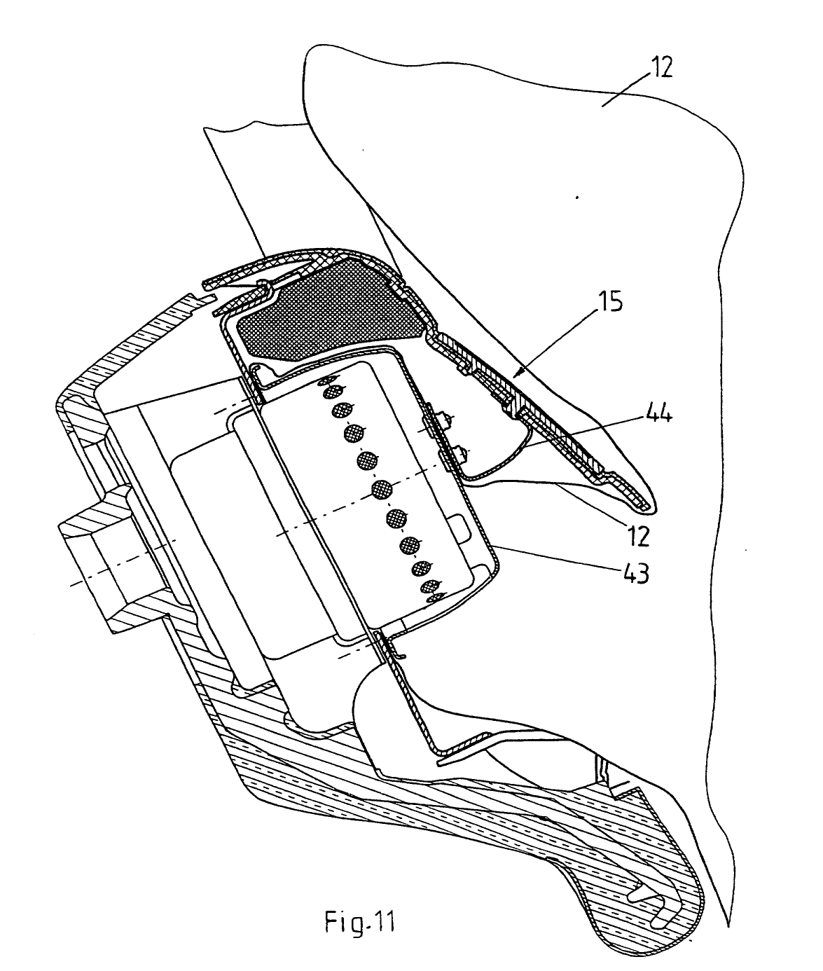

In the embodiment of FIGS. 10 and 11, the gas bag arrangement and the introduction of gas into the gas bag corresponds to the embodiment of FIGS. 5 to 7. However, as shown in FIGS. 10 and 11, the upper and the central regions 16, 17 can be opened by a small amount. For this purpose, a deformable element 44 is arranged between the gas-conducting device 43 and the cover 15. The gas bag 12 is additionally fastened in its lower region between the deformable element and the gas-conducting device 44.

The deformable element 44 is stretched through the deploying gas bag, as shown in FIG. 11. In this phase, the deformable element restricts the opening angle of the cover 15 in such a manner that the gas-conducting device 43 always remains covered. FIG. 11 shows the airbag module with a fully deployed gas bag 12. In the position illustrated in FIG. 11, the deformable element 44 may be able, in the event of a secondary collision, to absorb the energy of an impacting occupant to an acceptable level.

FIG. 12 illustrates the deployment of the gas bag 12 under OOP conditions in the case of an airbag module according to the invention. Prior to the deployment, the driver already has the forwardly inclined posture illustrated, i.e. he is positioned immediately in front of the steering wheel. In the first phase of deployment which is illustrated in FIG. 12, the gas bag 12 emerges downward and pushes with a section 12a between the lower region 26 of the steering wheel rim and the occupant's chest cage. A second section 12b of the gas bag 12 deploys in front of the lower region 26 of the steering wheel rim between the steering wheel spokes. As a consequence of this deployment in two directions, the load for the occupant in the OOP position is additionally reduced in the initial phase of the deployment. A subsequent deployment in the direction of the upper region of the steering wheel rim is completely or partially suppressed depending on the position of the occupant. Since the upper and central regions of the cover 15 do not change their position, the occupant in the OOP position is not subjected to a load by large-sized flap segments of the cover.

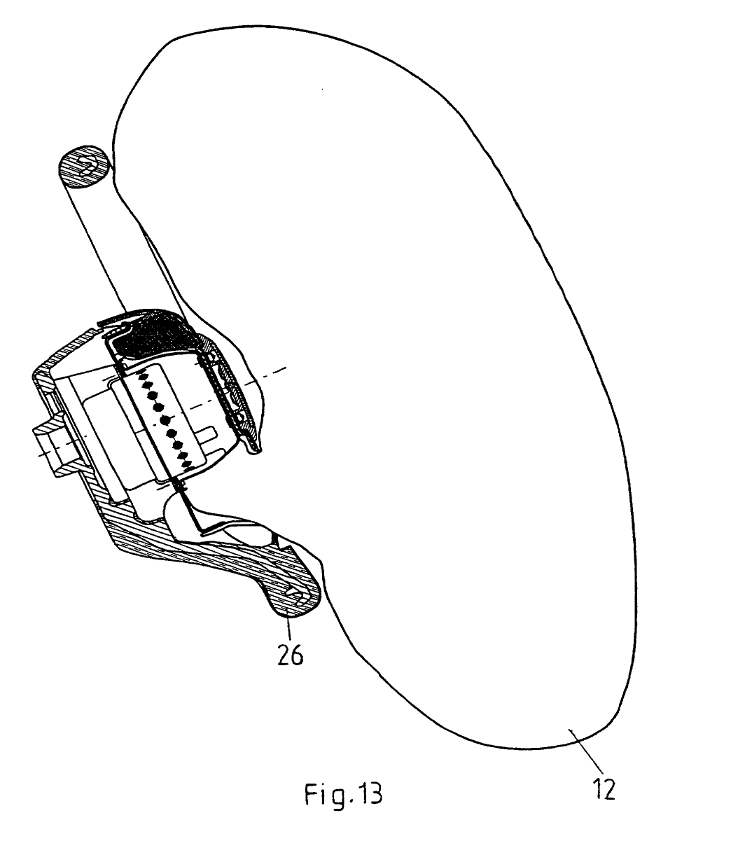

FIG. 13 shows the free deployment of the gas bag which occurs when the driver assumes the normal position, i.e. when he is at a sufficiently large distance from the steering wheel. The gas bag is, as illustrated in FIG. 12, oriented in the direction of the lower region 26 of the steering wheel rim on account of the modular arrangement according to the invention in the first phase of the deployment. Deployment subsequently takes place in the direction of the occupant and of the upper region of the steering wheel rim. The completely filled gas bag assumes the position illustrated in FIG. 13, covering the entire steering wheel.

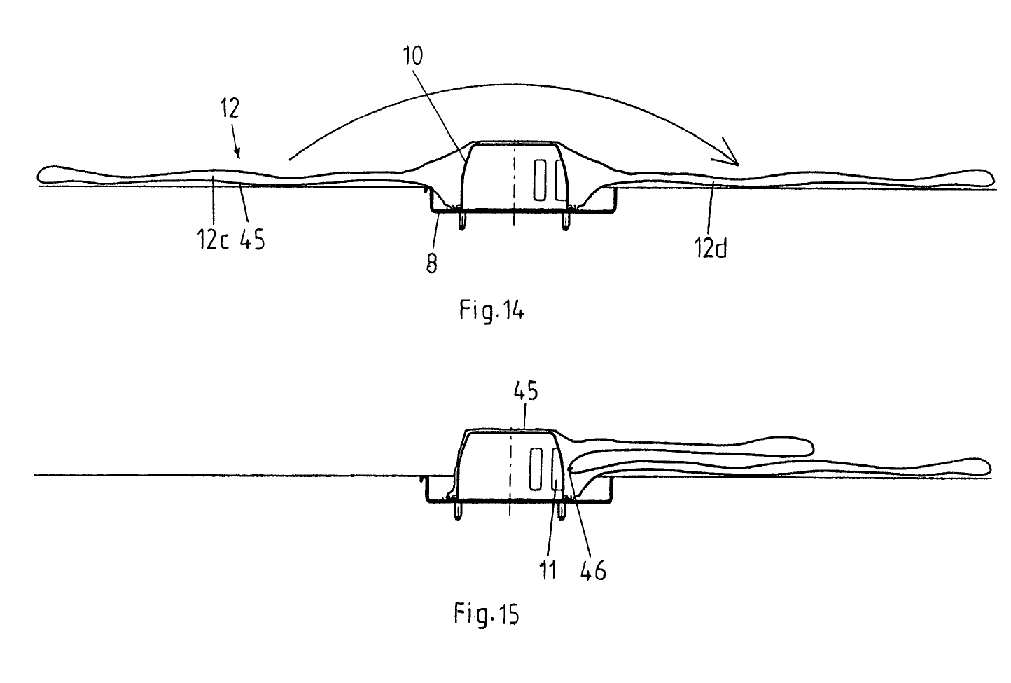

FIGS. 14 and 15 disclose a preferred folding for the airbag modules according to the invention. The gas bag 12, which is completed by the gas-conducting device 10 is placed together with the generator support 8 into the receptacle of a folding device (not shown) and is spread out. Subsequently, one section 12c of the gas bag 12 is turned over onto the opposite section 12d which, during the subsequent installation of the airbag module into the steering wheel, extends in the direction of the lower region 26 of the steering wheel rim (shown in FIG. 12). The gas bag is positioned in such a manner that the lower side 45 of the gas bag—in the case of a two-part gas bag this is the lower panel of the gas bag—lies in a single layer above the gas-conducting device 10 and that the fold edge 46 is positioned directly in front of the outflow openings 11. During the folding process the relationship between the gas bag sections 12c and 12d shown in FIGS. 5-7 is maintained providing the gas-bag free region. Folding sliders (not illustrated) which can be moved in the direction of the gas-conducting device parallel to the plane of the table, in which the gas bag is spread out during the folding process, gather together the gas bag into the shape illustrated, for example, in FIGS. 5 to 7.

As an alternative to this, the gas bag can be gathered directly in the manner mentioned without the folding over step. The upper side of the gas bag—in the case of a two-part gas bag this is the upper panel of the gas bag—lies in a single layer above the gas-conducting device, and the gas bag package illustrated in FIGS. 1 to 3 may be produced.

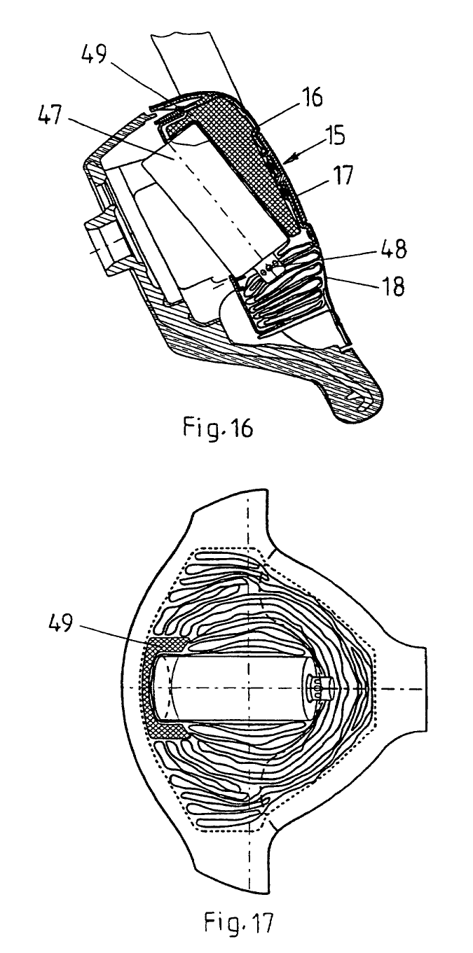

In the embodiment of FIGS. 16 and 17, a tubular gas generator 47 is in an inclined position. The discharge openings 48 are located in the lower region 18 of the cover, i.e. in the opening region of the cover. As a result, a gas-conducting device having outflow openings 11 arranged in the lower region is not required. Extending above the tubular gas generator 47 is a spacer 49 which ensures the U-shape of the folded gas bag package (FIG. 17). Furthermore, the spacer 49 runs in the space between the upper and central regions 16, 17 of the cover 15 and the tubular gas generator 47, over the entire length thereof, and is designed as a deformable or resilient element.

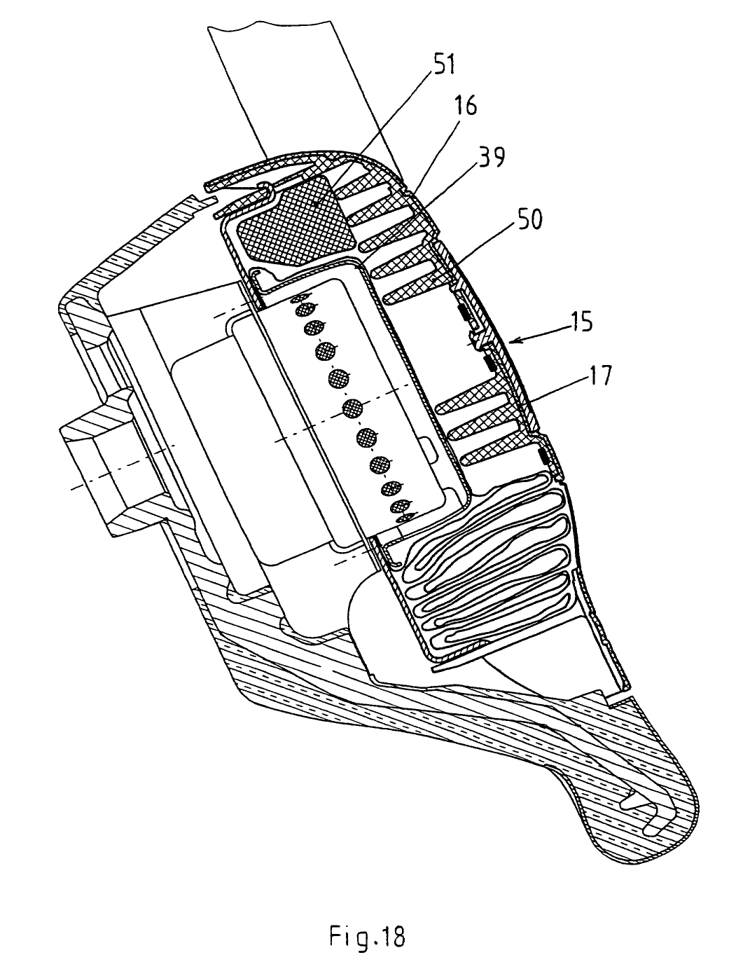

In the embodiment of FIG. 18, as in the embodiment of FIG. 9, a flat gas-conducting device 39 is provided. Deformable elements 50 in the form of ribs are injection-molded onto the upper and central regions 16, 17 of the cover 15. The deformable elements extend into the space between the cover 15 and the gas-conducting device 39 and between the cover 15 and a spacer 51. As in the embodiment of FIG. 5, the spacer 51 is provided above the gas-conducting device 39.

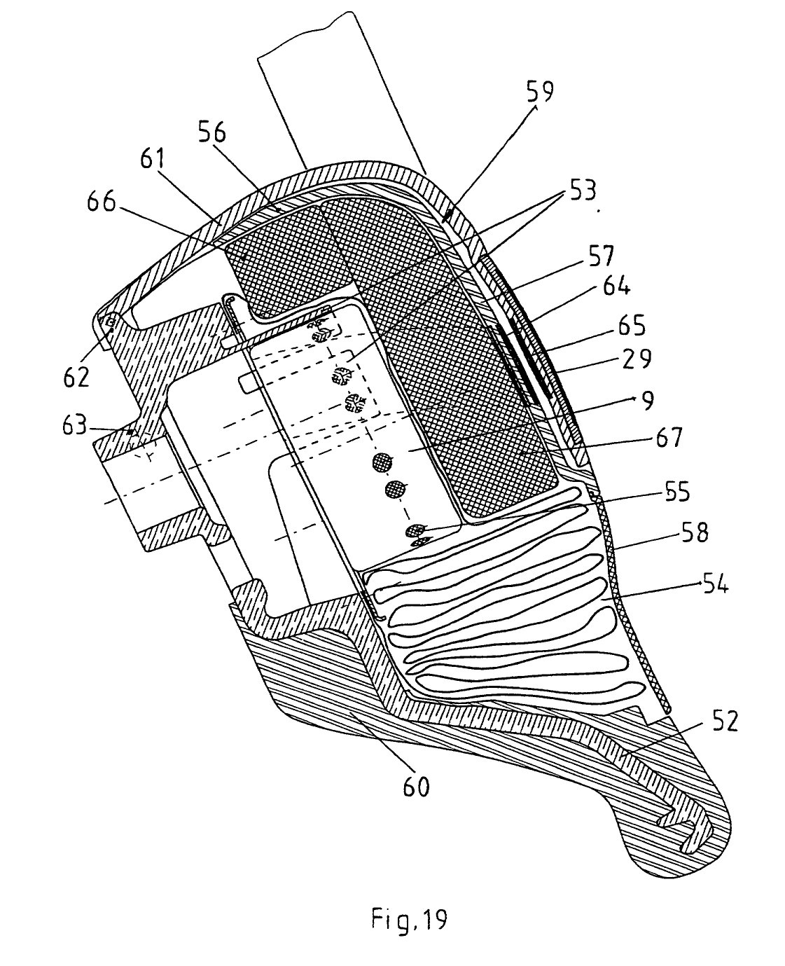

In the embodiment of FIG. 19, the gas-conducting device and the cover may be an integral part of the steering wheel. In this embodiment, the gas-conducting device is an integral part of the steering wheel frame 52. The gas-conducting device comprises annular segments 53 which partially surround the gas generator 9, thereby leaving open the generator discharge openings 55 which face the opening region 54.

The fixed upper and central region 56, 57 of the cover 59 is part of the foam encapsulation 60 of the frame. The lower region 58 of the cover 59 is fastened as a separate part to the steering wheel via suitable means (not illustrated). Tearing seams are not provided between the upper/central region 56, 57 and the lower region 58; rather, these sections are connected by a form fit.

As shown in FIG. 19, there may be a clip-like actuating element 61 for the horn. The actuating element 61 may be articulated on a section 62 of the steering wheel frame level with the steering wheel hub 63 and reaches over the upper and central regions 56, 57 of the cover 59. A horn contact 64 is provided in the central region 57 and a horn contact 65 lies opposite in the actuating element 61. The central region 57 is recessed inwardly from the lower region 58 of the cover, with the result that the surfaces of the actuating element 61 and of the lower region 58 may be aligned with each other. The company logo 29 may be provided in the actuating element 61.

As shown in FIG. 19, two spacers are provided, one spacer 66 being arranged above the gas generator 9 and the second spacer 67 being arranged essentially in the space between the gas generator 9 and the central region 57 of the cover.

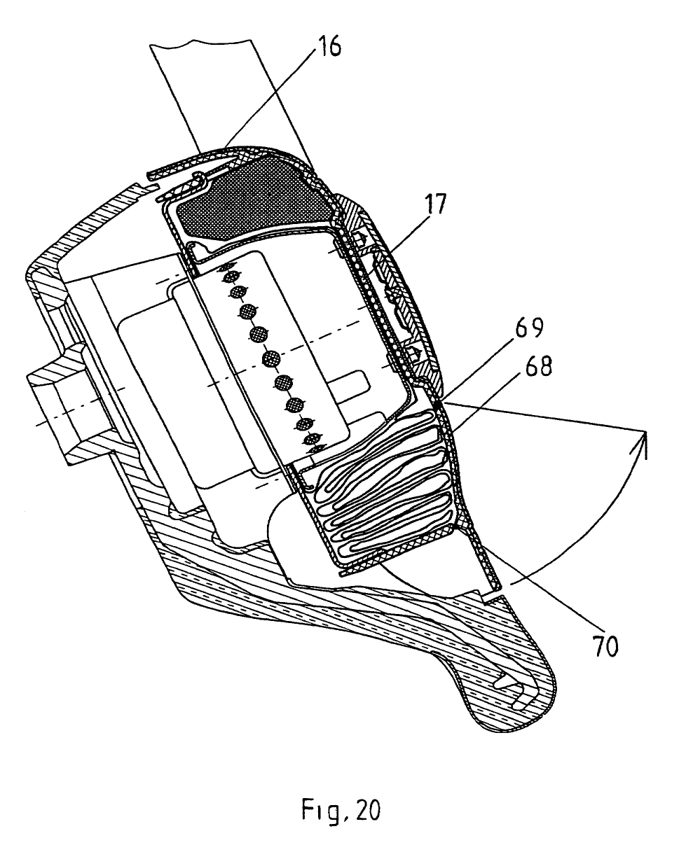

In the embodiment of FIG. 20, an upper and central region 16, 17 are provided as illustrated in FIG. 5. A lower region 68 of the cover is provided, which region is connected to the central region 17 via a film hinge 69. The lower region 68 opens from the edge regions first. For this purpose, tearing seams 70 run below the cover in the edge regions of the lower region 68. As a result, the pressure of the gas bag package against the inside of the cover does not result in the tearing seams becoming marked on the outside. As an alternative to this, the lower region 68 can be formed without an edge in the outlet region of the gas bag.

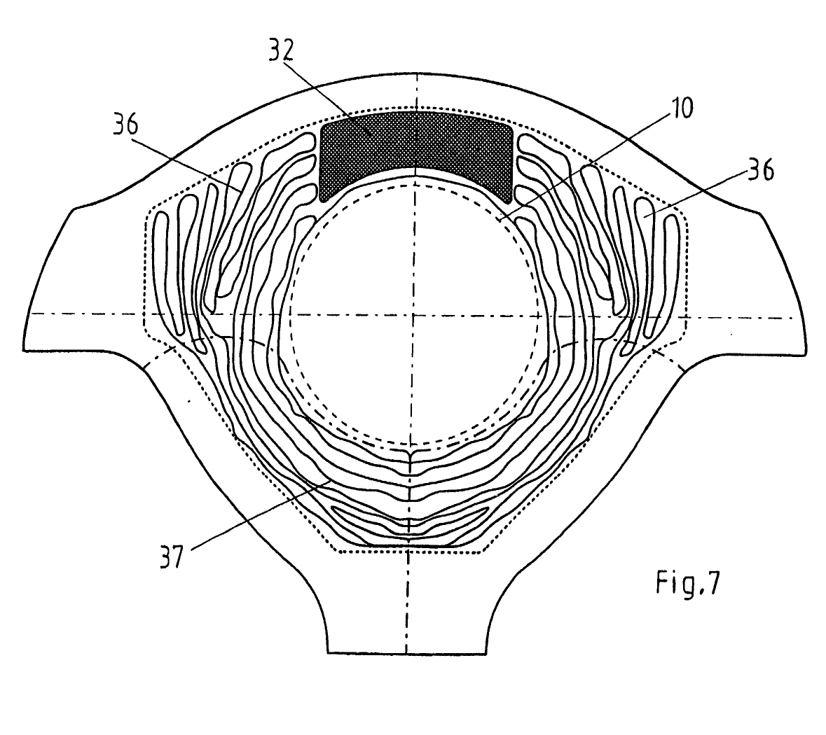

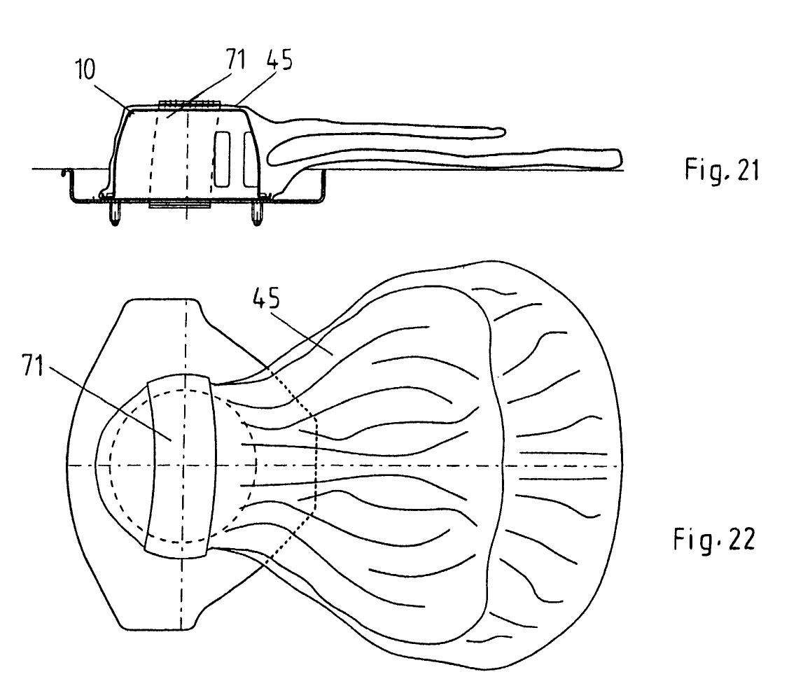

In FIGS. 21 and 22, the folding state of the gas bag corresponding to FIG. 15 is illustrated. As shown in FIGS. 21 and 22, the airbag module is equipped with means which at least temporarily fix the gas bag in place during the deployment above the gas-conducting device 10 or above the gas generator. Thus, the effect of force on those regions of the cover above the gas generator. A strap 71, which is sewn to the lower panel 45 of the gas bag and, after folding over has taken place, loops tightly around the gas bag, is provided as fixing means. Instead of the strap 71, a clip made of rigid material may also be provided. After the folding, the gas bag distribution illustrated in FIG. 7 may be provided.

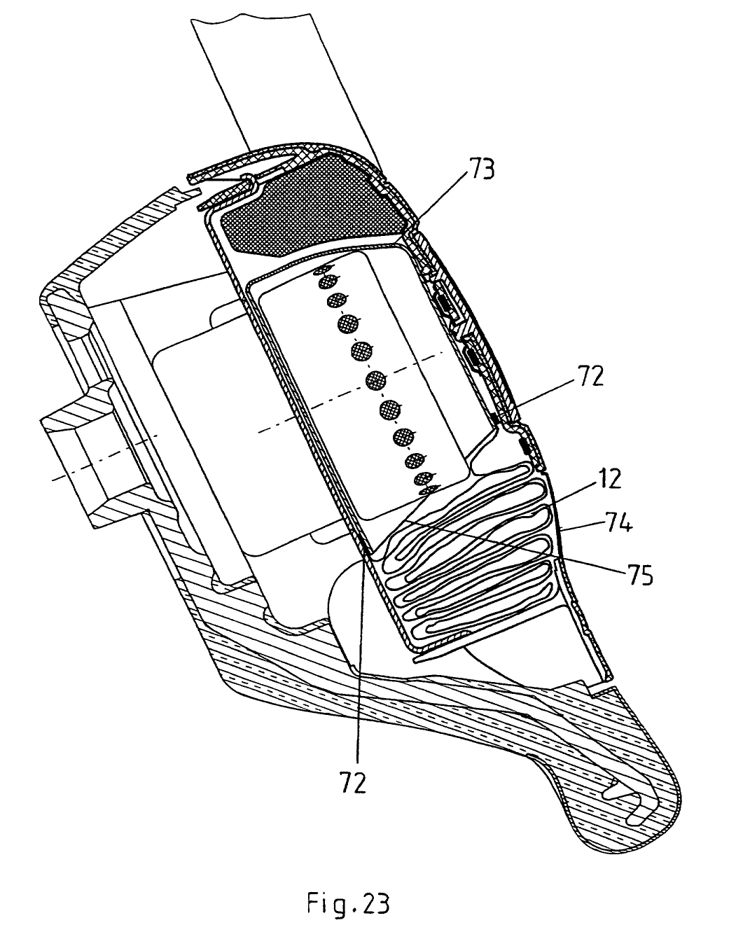

In the embodiment of FIG. 23, the gas bag 12 is fastened in a different manner from the preceding embodiments of the present invention. The gas bag is fastened with the aid of fastening means 72 to a gas-conducting device 73, in the region of the gas outlet opening 75 which is oriented in the direction of the lower region 74 of the cover. Therefore, unlike in the other embodiments, in this embodiment there is no gas-bag layer between the gas-conducting device and the cover. This results in the further advantage that the forces acting on the cover during the deployment of the gas bag are minimal.

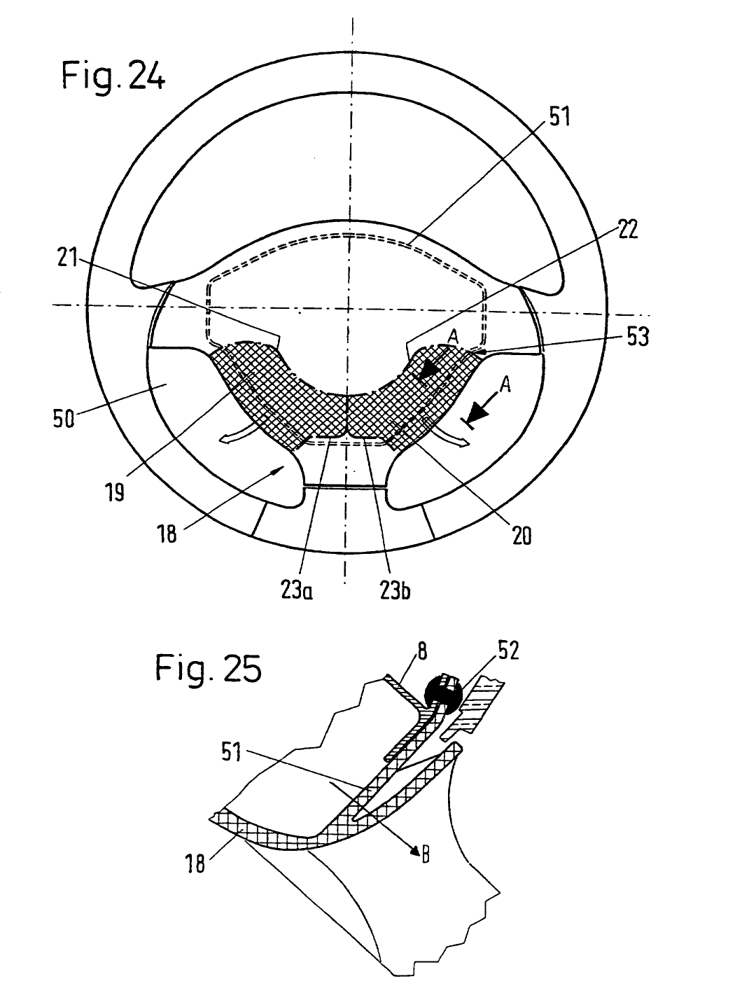

FIGS. 24 and 25 show an embodiment in which the cover has a side wall 51 which is connected to the base of the generator support 8. In a similar manner to FIG. 2, the two segments 19, 20 of the lower region 18 of the cover have tear-open lines 21, 22, 23a, 23b. In this embodiment, the tear-open lines extend through the side wall 51 as far as the edge of the cover.

The side wall 51 of the cover is connected fixedly to the generator support 8 in the region of the respective segments 19, 20. In the exemplary embodiment of FIG. 25, the connection is produced by a rivet connection 52. When the gas bag is deployed, the segments 19, 20 swing downward, the point 52 at which the side wall is bound to the generator support 8 serving as a pivot. In order to enable the segments 19, 20 to swing open along the line at which the side wall is bound to the base of the generator support 8, the tear-open lines extend to the points 53 to intersect with the side wall 51 and then on further through the side wall as far as the edge of the cover, i.e. the side wall is notched or interrupted at this point.

This connecting of the segments 19, 20 to the generator support 8 enables the segments 19, 20 to swivel after opening, into clearances 50 between the spokes of the steering wheel.

The desired direction of deployment of the gas bag in an OOP situation is indicated in FIG. 25 by the arrow B. In order, under OOP conditions, to obtain a deployment of the gas bag which is as lateral as possible and to facilitate the deployment in front of the steering wheel spider (corresponding to FIG. 12, section 12b of the gas bag), the side wall 51 is connected in the vicinity of the base of the generator support (as shown in FIG. 25). This enables a large, lateral opening cross section.

This embodiment therefore enables the cover segments 19, 20 to be torn open in such a manner that the segments swivel into the clearances 50 between the spokes. In this embodiment, the tear-open lines run through the side wall as far as the edge of the cover. In order to obtain a lateral opening cross section which is as large as possible, the side wall is connected in this region to the generator support in the vicinity of the base of the support.

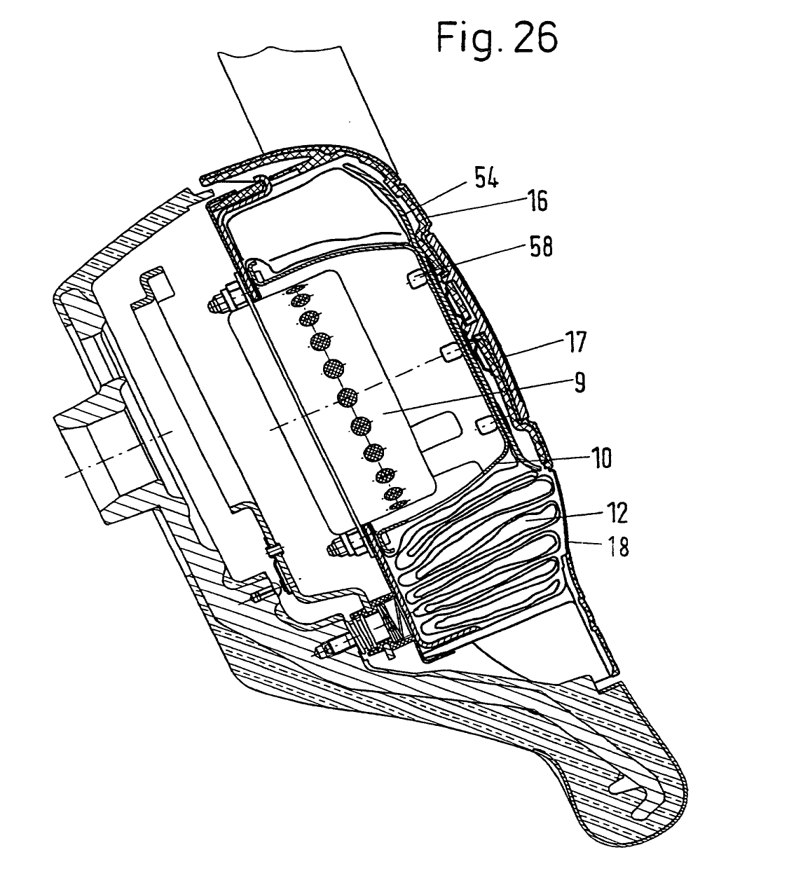

In FIG. 26, a cover plate 54 is arranged between the upper region 16 and the central region 17 of the cover and the folded gas bag 12. The cover plate, as seen by the driver, has an outer contour which extends approximately along the upper side wall of the cover and tear-open lines located between the upper/central region 16, 17 and the lower region 18 to be opened. The cover plate 54 is connected fixedly to the gas-conducting device 10 located below it, for example, is riveted to the device via rivet connections 58. As shown in FIG. 26, a layer of the gas bag is clamped between the gas-conducting device 10 and the cover plate 54.

The cover plate helps to keep the forces and loads which arise when the gas generator 9 is ignited, due to the deploying gas bag 12, away from those regions 16, 17 of the cover which are not to be opened.

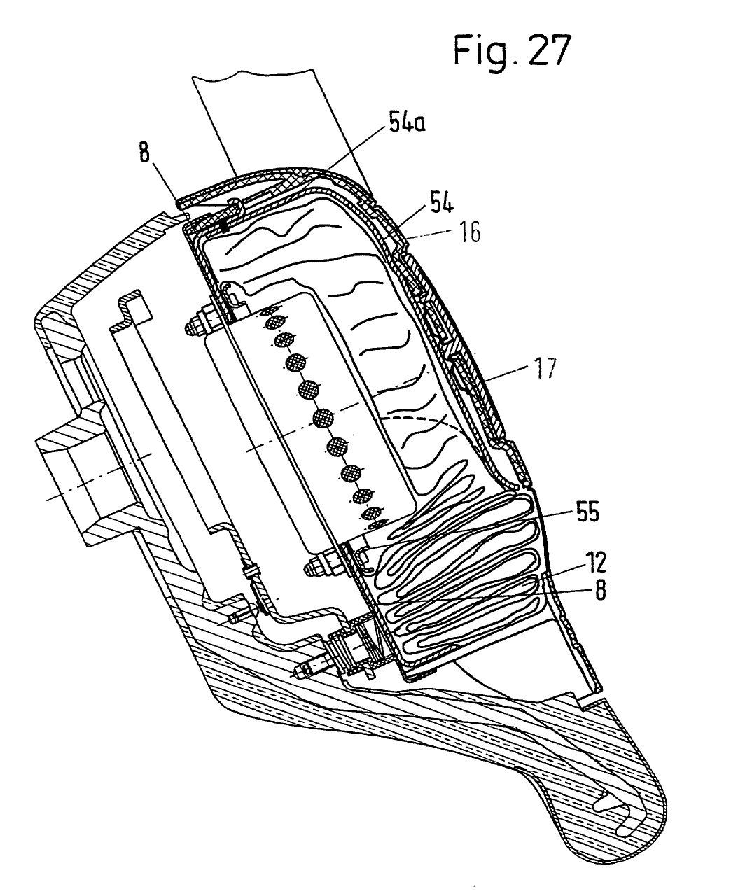

In FIG. 27, a cover plate 54 according to FIG. 26 is likewise provided. Unlike in the embodiment of FIG. 26, the cover plate 54 has, at least in part, side walls 54a along which the cover plate is connected to the generator support 8. A further difference in comparison to FIG. 26 is that there is no gas-conducting device. The gas bag 12 is therefore fastened directly to the generator support 8 via a retaining ring 55. As shown in FIG. 27, a housing which is closed below the upper/central region 16, 17 of the cover is provided which partially surrounds the gas bag 12.

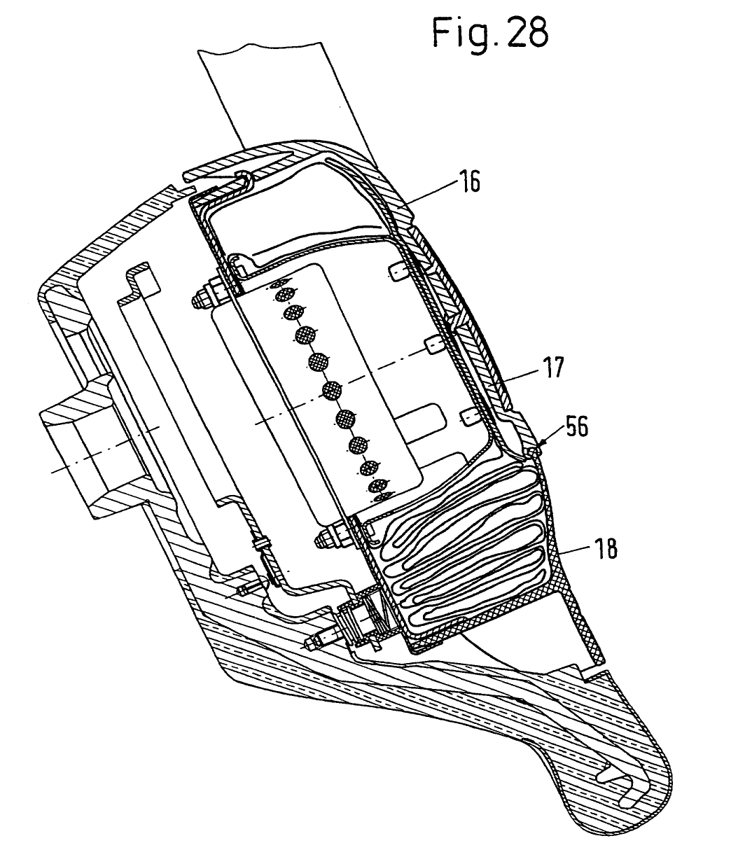

FIG. 28 discloses an embodiment in which the upper and central regions 16, 17 on the one hand, and the lower region 18, on the other hand consist of different materials. For example, the fixed upper/central region 16, 17 consists of metal, while a plastic material is provided for that region 18 of the cover which is to be opened. The two regions and materials of the cover are connected in a form-fitting manner to one another. For this purpose, a groove or recess 56 is provided, for example, on the lower edge of the central region 17 according to FIG. 28, in which an upper edge of the lower region 18 engages in a form-fitting manner. As a possible supplement to the means described already, the use of different materials can ensure that when the gas bag is deployed, only that region 18 of the cover which is located at the bottom opens.

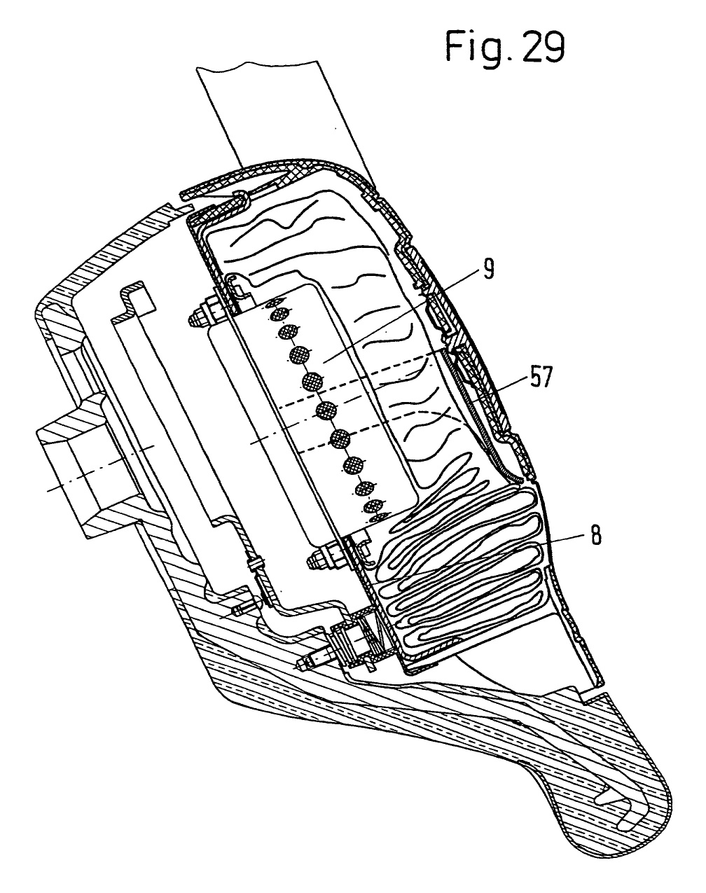

Finally, as shown in FIG. 29, a clip-like element 57 may be provided which, as seen by the driver, extends in the transverse direction and is connected in the edge region of the gas bag package to the generator support 8 (indicated by dashed lines). The gas bag 12 is therefore enclosed essentially over its entire width by the clip 57 and is therefore continuously fixed in place during deployment of the gas bag over the gas-conducting device or the gas generator 9. Opening of the cover is therefore possible only in its region located at the bottom.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag module for a steering wheel for protecting a driver of a vehicle, the module comprising a cover facing the driver, wherein the cover is adapted to be fully opened only in a lower region located at the bottom of the cover when the steering wheel is in a straight-ahead position.

2. The airbag module of claim 1, wherein the region adapted to be fully opened lies substantially below a line extending perpendicular to the direction of vehicle travel and intersecting the central axis of the steering column.

3. The airbag module of claim 1, wherein the cover includes a central region, adjoining the lower region adapted to be opened, and an upper region, the upper and central regions having reinforcing elements preventing these regions from tearing open.

4. The airbag module of claim 3, wherein the central and upper regions of the cover are connected to a gas-conducting device located below the cover.

5. The airbag module of claim 3, wherein the central and upper regions of the cover are integrally formed with the steering wheel.

6. The airbag module of one of claim 3, wherein the central and upper regions of the cover are connected by deformable elements to a fixed component of the airbag module, the fixed component being located below the cover, wherein the central and upper regions of the cover are adapted to be opened by a predetermined amount, the deformable elements forming boundaries for the predetermined opening and providing energy-absorption in the event of a secondary impact of the driver.

7. The airbag module of claim 6, wherein the location of a maximum opening produced by the opening of the central and upper regions faces the lower region of the cover.

8. The airbag module of claim 3, wherein the central and upper regions of the cover are configured to substantially cover a gas-conducting device located below the cover.

9. The airbag module as in claim 3, wherein the central and upper regions of the cover are adapted to absorb energy.

10. The airbag module of claim 9, wherein the space between the cover and a gas-conducting device is filled with foam.

11. The airbag module of claim 9, wherein the space between the cover and a gas-conducting device is bridged by at least one deformable element.

12. The airbag module of claim 11, wherein the deformable element is in the form of ribs located on the upper or central region of the cover.

13. The airbag module of claim 1, further comprising a spacer located in a region of the airbag module located at the top of the module when the steering wheel is in the straight-ahead position.

14. The airbag module of claim 13, wherein the spacer is deformable.

15. The airbag module of claim 1, further comprising a gas-conducting device having openings facing the fully opening, lower region of the cover.

16. The airbag module of claim 15, wherein the gas-conducting device is deformable.

17. The airbag module of claim 15, wherein the gas-conducting device is an integral part of a gas generator.

18. The airbag module of claim 15 further comprising a folded gas bag wherein the folded gas bag is adjacent to and fully surrounds the gas-conducting device.

19. The airbag module of claim 15, wherein a gas bag of the airbag module is folded so that just one gas bag layer lies above the gas-conducting device.

20. The airbag module of claim 15, fully comprising a folded gas bag wherein the folded gas bag is positioned adjacent to the gas-conducting device in a U-shaped manner.

21. The airbag module of claim 20, wherein the region of the airbag module which is located at the top when the steering wheel is in the straight ahead position is kept free of the gas bag material.

22. The airbag module of claim 20, wherein the two limbs of the U-shaped folded gas bag are in contact in that region of the airbag module which is located at the top during straight-ahead travel.

23. The airbag module of claim 15, wherein means are provided for the at least temporary fixing of a portion of the gas bag located above the gas-conducting device in place during the deployment of the gas bag.

24. The airbag module of claim 15, wherein a gas bag of the module is tied down adjacent to the openings facing the lower region of the cover.

25. The airbag module of claim 1, including an air bag wherein an opening of the gas bag for receiving pressurized gas is arranged centrally with regard to an outer contour of the gas bag.

26. The airbag module of claim 3, wherein actuating elements are arranged in the central and upper regions of the cover.

27. The airbag module of claim 1, wherein the cover includes a side wall which is interrupted in the lower region of the cover by tear-open lines.

28. The airbag module of claim 27, wherein the lower region of the cover has segments which swivel into clearances between spokes of the steering wheel when the gas bag is deployed.

29. The airbag module of claim 28, wherein the side wall is connected in the region of the segments to a support element for a gas generator.

30. The airbag module of claim 29, wherein the side wall is connected to the support element for the gas generator in the vicinity of a base of the support element.

31. The airbag module of claim 3, wherein a cover plate is arranged between the upper and central regions of the cover and a folded gas bag.

32. The airbag module of claim 31, wherein the cover plate is connected to a gas-conducting device.

33. The airbag module of claim 31, wherein the cover plate has side walls which are connected to a support element for a gas generator.

34. The airbag module of claim 33, wherein the cover plate and the support element of the gas generator are integral.

35. The airbag module of claim 3, wherein the upper and central regions of the cover comprise different materials from the lower region.

36. The airbag module of claim 35, wherein the upper region of the cover comprises a metal and the lower region of the cover comprise plastic.

37. The airbag module of claim 35, wherein the upper and central regions of the cover and the lower region of the cover are connected to one another in a form-fitting manner.

38. The airbag module of claim 15, further comprising means for continuously fixing the gas bag in place during its deployment above the gas-conducting device.

39. The airbag module of claim 38, wherein the fixing means fix the gas bag in place at least below the central region of the cover.

40. The airbag module of claim 39, wherein the fixing means are connected at least to the central region of the cover.

41. The airbag module of one of claims 38, wherein the fixing means have an essentially transversely extending, clip-like element which is connected to a support element for the gas generator.
